(19) United States
(12) Patent Application Publication
(10) Pub. No.: US 2025/0046836 A1
(43) Pub. Date: Feb. 6, 2025

(54) AIR-COOLED FUEL CELL SYSTEM

(71) Applicant: TOYOTA JIDOSHA KABUSHIKI KAISHA, Toyota-shi (JP)

(72) Inventors: Nobuaki NONOYAMA, Chiryu-shi (JP); Takahiro UMEHARA, Susono-shi (JP)

(73) Assignee: TOYOTA JIDOSHA KABUSHIKI KAISHA, Toyota-shi (JP)

(21) Appl. No.: 18/787,472

(22) Filed: Jul. 29, 2024

(30) Foreign Application Priority Data
Jul. 31, 2023 (JP) 2023-124081

(51) Int. Cl. H01M 8/04228; H01M 8/04007; H01M 8/04014; H01M 8/04746

(52) U.S. Cl. CPC H01M 8/04228; H01M 8/04014; H01M 8/04067; H01M 8/04753; H01M 8/04768

(57) ABSTRACT

To provide a fuel cell system capable of suppressing deterioration of a fuel cell. An air-cooled fuel cell system, wherein the fuel cell system comprises a fuel cell, a hydrogen system for supplying hydrogen to the fuel cell, a reaction air system for supplying reaction air to the fuel cell, and a cooling air system for supplying cooling air to the fuel cell; wherein the fuel cell comprises a reaction air flow path and a cooling air flow path and has a flow path structure in which the reaction air and the cooling air are independent.

### CROSS-REFERENCE

This application claims priority to Japanese Patent Application No. 2023-124081 filed on Jul. 31, 2023, incorporated herein by reference in its entirety.

### TECHNICAL FIELD

The present disclosure relates to an air-cooled fuel cell system.

### BACKGROUND

Various studies have been proposed for fuel cells (FC) as disclosed in Patent Documents 1 to 6.
Patent Document 1: Japanese Patent Application Laid-Open (JP-A) No. 2005-216783
Patent Document 2: JP-A No. 2012-505496
Patent Document 3: JP-A No. 2007-115533
Patent Document 4: JP-A No. H06-022155
Patent Document 5: JP-A No. 2022-185251
Patent Document 6: JP-A No. 2022-185247

In the case of an open-type air-cooled fuel cell, if the air supply is stopped when the system is shut down, the cathode is exposed to the air. Accordingly, an abnormal potential is generated in the cell of the fuel cell, resulting in deterioration of the fuel cell.

### SUMMARY

The disclosure was achieved in light of the above circumstances. An object of the disclosure is to provide an air-cooled fuel cell system capable of suppressing deterioration of a fuel cell.

In the first embodiment of the present disclosure, there is provided an air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent;
wherein the reaction air system comprises an inlet-side sealing valve at an inlet for the reaction air of the fuel cell and an outlet-side sealing valve at an outlet for the reaction air of the fuel cell; and
wherein, when the fuel cell system is shut down, the fuel cell system is configured to stop the supply of the reaction air to the fuel cell, while continuing the supply of the hydrogen to the fuel cell and the supply of the cooling air to the fuel cell; the fuel cell system is configured to close the inlet side sealing valve and the outlet side sealing valve to seal the cathode of the fuel cell; and then, the fuel cell system is configured to stop the supply of the hydrogen to the fuel cell, while continuing the supply of the cooling air to the fuel cell intermittently or continuously.

According to the second embodiment of the present disclosure, in the first embodiment, the reaction air system may comprise a reaction air blowing device; the cooling air system may comprise a cooling air blowing device; and a hydrogen discharge flow path of the hydrogen system may merge with a cooling air discharge flow path of the cooling air system.

According to the third embodiment of the present disclosure, in the first embodiment, the fuel cell system may comprise an electrical system, and the fuel cell system may be configured to connect the fuel cell to a power line of the electrical system when the fuel cell system is shut down.

According to the fourth embodiment of the present disclosure, in the first embodiment, the hydrogen system may comprise a hydrogen pump.

The present disclosure can suppress deterioration of the fuel cell.

### BRIEF DESCRIPTION OF THE DRAWINGS

In the accompanying drawings,

FIG. 1 is a schematic exploded perspective view showing an example of a unit cell of the fuel cell included in the fuel cell system of the present disclosure;

FIG. 2 is a schematic perspective view showing an example of a fuel cell stack included in the fuel cell system of the present disclosure;

FIG. 3 is a system configuration diagram showing an example of the fuel cell system of the present disclosure;

FIG. 4 is a circuit diagram showing an example of the electrical system included in the fuel cell system of the present disclosure;

FIG. 5A shows a shutdown sequence of the fuel cell system;

FIG. 5B shows a shutdown sequence in a fuel cell system configuration including a hydrogen pump, a relay and a diode; and

FIG. 6 is a flowchart showing another example of the control of the fuel cell system of the present disclosure.

### DETAILED DESCRIPTION

Hereinafter, the embodiments of the present disclosure will be described in detail. Matters that are required to implement the present disclosure (such as common a fuel cell system structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relationships (length, width, thickness, and the like) in the drawings do not reflect actual dimensional relationships.

In the present disclosure, the gas supplied to the anode of the fuel cell is a fuel gas (anode gas), and the gas supplied to the cathode of the fuel cell is an oxidant gas (cathode gas). The fuel gas is a gas mainly containing hydrogen, and may be hydrogen. The oxidizing gas is a gas containing oxygen, and may be oxygen, air, or the like. In the present disclosure, air as an oxidant gas is referred to as reaction air, and air as a cooling gas is referred to as cooling air.

In the present disclosure, there is provided an air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent;
wherein the reaction air system comprises an inlet-side sealing valve at an inlet for the reaction air of the fuel cell and an outlet-side sealing valve at an outlet for the reaction air of the fuel cell; and
wherein, when the fuel cell system is shut down, the fuel cell system is configured to stop the supply of the reaction air to the fuel cell, while continuing the supply of the hydrogen to the fuel cell and the supply of the cooling air to the fuel cell; the fuel cell system is configured to close the inlet side sealing valve and the outlet side sealing valve to seal the cathode of the fuel cell; and then, the fuel cell system is configured to stop the supply of the hydrogen to the fuel cell, while continuing the supply of the cooling air to the fuel cell intermittently or continuously.

When air is partially mixed into the anode due to cross leakage or the like while the fuel cell system is stopped, the catalyst layer is partially exposed to a high potential in the cell surface of the fuel cell, and the catalyst layer deteriorates. In order to prevent the occurrence of a situation referred to as an abnormal potential, it is necessary to consume oxygen in the cathode and keep the cell voltage sufficiently low during the shutdown process of the fuel cell system.

In an air-cooled fuel cell, a volume of a fluid used for cooling is larger than in a water-cooled fuel cell, and a flow path structure for flowing a fluid is also larger.

For example, the cooling water required to cool 4 kW needs to be 5 L/min or more than 10,000 L/min.

When the power generation operation of the fuel cell is continued, the catalytic activity decreases due to the accumulation of the oxide on the catalyst surface of the cathode, and the power generation efficiency decreases.

In a general open air-cooled fuel cell, the opening of the air system is large, and it is difficult to seal the cathode at the end of power generation of the fuel cell. After the power generation is stopped, air flows into the cathode, and the electrolyte membrane is cross-leaked, and oxygen is also mixed into the anode. This condition is a state in which an abnormal potential of the fuel cell is generated, and deterioration of the catalyst layer cannot be avoided. The short lifetime of a typical open air-cooled fuel cell is less than 1000 hours, which is mainly due to the occurrence of an abnormal potential. In addition, even when the cathode is sealed, the space volume is large, and it takes time to sufficiently reduce oxygen in the cathode space, and if oxygen remains, the fuel cell becomes an abnormal potential during system shutdown.

When hydrogen is introduced into the cathode and the anode without a current flowing therethrough, the potential of the cell of the fuel-cell becomes a high potential (about 0.95˜1.05V). In this condition, the deterioration of the fuel cell progresses, albeit gently. In addition, an oxide film is formed on Pt catalyst, which causes deterioration in the performance of the catalyst. In order to avoid this, the potential of the cells of the fuel-cell may be constantly operated at a 0.85V or lower.

The present disclosure relates to performance improvement of an air-cooled fuel cell, and proposes a configuration and a method for smoothly stopping a system while preventing generation of an abnormal potential of the fuel cell, deterioration of the fuel cell, and the like. A fuel cell having a flow path structure in which the reaction air and the cooling air are independent is stopped by a predetermined procedure. When the system is stopped, the supply of the reaction air is stopped, the cathode is shut off from the outside of the fuel cell system, and the reaction air is consumed and then stopped, so that deterioration of the fuel cell can be suppressed. The hydrogen discharge in the shutdown step can be diluted with cooling air.

The fuel cell system includes a fuel cell in which hydrogen and air react to generate power, a hydrogen system in which hydrogen necessary for power generation of the fuel cell is supplied to the fuel cell, a reaction air system in which reaction air is supplied to the fuel cell, and a cooling air system in which cooling air for cooling heat generated by power generation is supplied to the fuel cell.

The fuel cell may have only one unit cell of the fuel cell, or may be a fuel cell stack which is a stack in which a plurality of unit cells are stacked.

In the present disclosure, both the unit cell and the fuel cell stack may be referred to as a fuel cell.

The number of stacked unit cells in the fuel cell stack is not particularly limited, and may be, for example, 2 to several hundred.

The fuel cell stack may have corrugated cooling fins that serve as the cooling air flow path in each unit cell.

The fuel cell stack may include a current collector plate, a pressure plate, and the like at an end portion in the stacking direction.

The unit cell of the fuel cell may have a reaction air flow path (oxidant gas flow path) and a cooling air flow path (cooling gas flow path) having a flow path structure in which the reaction air and the cooling air are independent, and may further have a hydrogen gas flow path (fuel gas flow path).

The flow path structure in which the reaction air and the cooling air are independent means that there is no sharing of air between the flow paths from the supply of air to the fuel cell to the discharge of air from the fuel cell. The flow path for discharging the air discharged from the fuel cell to the outside of the fuel cell system may be independent or may not be independent.

The unit cell may have a flow path structure for flowing the reaction air and the cooling air so that the flow of the cooling air and the flow of the reaction air intersect each other in a plan view. The flow of cooling air and the flow of reaction air may intersect or be orthogonal.

The unit cell may include a power generation unit.

The shape of the power generation unit may be a rectangular shape in a plan view.

The power generation unit may be a membrane electrode assembly (MEA) including an electrolyte membrane and two electrodes.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are an anode (fuel electrode or hydrogen electrode) and a cathode (oxygen electrode or air electrode).

The electrode includes a catalytic layer, and may optionally include a gas diffusion layer, and the power generation unit may be a membrane electrode gas diffusion layer assembly (MEGA).

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The gas diffusion layer may be a conductive member or the like having pores.

Examples of the conductive member include a carbon porous body such as carbon cloth and carbon paper, and a metal porous member such as a metal mesh and a metal foam.

The unit cell of the fuel cell may include a separator.

The separator collects current generated by power generation and functions as a partition wall. In a unit cell of a fuel cell, the separator is usually disposed on both sides of the power generation unit in the stacking direction so that a pair of separators sandwich the power generation unit. One of the pair of separators is an anode separator and the other is a cathode separator.

The anode separator may have a groove that serves as a hydrogen gas flow path on a surface on the side of the power generation unit, and may have a groove that serves as a cooling air flow path on a surface on the side opposite to the power generation unit.

The cathode separator may have a groove that serves as a reaction air flow path on a surface on the side of the power generation unit, and may have a groove that serves as a cooling air flow path on a surface on the side opposite to the power generation unit.

The separator may have holes constituting a manifold such as a supply hole and a discharge hole for allowing fluid to flow in the stacking direction of the unit cells.

The separator may be, for example, dense carbon obtained by compressing carbon to make it impermeable to gas, and press-formed metal (for example, iron, titanium, stainless steel, and the like).

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and seals between the anode separator and the cathode separator in a condition where the membrane electrode assembly is held in a central region thereof. As the resin frame, for example, a resin such as PE, PP, PET, PEN can be used. The resin frame may be a three-layer sheet composed of three layers in which an adhesive layer is disposed on a surface layer.

The fuel cell system may include a control device. The control device may control the entire fuel cell system by controlling the reaction air system, the hydrogen system, the cooling air system, and the like.

The control device physically includes, for example, an arithmetic processing unit such as a CPU (central processing unit), a ROM (read-only memory) that stores control programs and control data to be processed by CPU, a storage device such as a RAM (random access memory) that is mainly used as various working areas for the control processing, and an input/output interface, and may be a ECU (electronic control unit).

The reaction air system supplies reaction air as an oxidant gas to the fuel cell and regulates a flow rate of the reaction air. The reaction air system may include a reaction air pipe or the like.

The hydrogen system supplies hydrogen as a fuel gas to the fuel cell and adjusts the flow rate of the hydrogen. The hydrogen system may include a hydrogen tank, a hydrogen inlet valve, an injector, a gas-liquid separator, a hydrogen purge valve, an ejector for hydrogen circulation, a hydrogen pump for hydrogen circulation, and a hydrogen pipe.

The cooling air system supplies cooling air as a cooling gas to the fuel cell and regulates a flow rate of the cooling air.

The reaction air system has an inlet-side sealing valve at the inlet of the reaction air of the fuel cell and an outlet-side sealing valve at the outlet of the reaction air of the fuel cell.

In the present disclosure, the fuel cell has a flow path structure in which the reaction air and the cooling air are independent from each other, and in the reaction air system, a valve (an inlet-side sealing valve and an outlet-side sealing valve) is installed at the inlet and outlet of the reaction air of the fuel cell, so that the fuel cell can seal the cathode of the fuel cell with a smaller volume as compared with a case where the reaction air and the cooling air have a common flow path structure.

The reaction air system may have a reaction air blowing device, the cooling air system may have a cooling air blowing device, and the hydrogen discharge flow path of the hydrogen system may merge with the cooling air discharge flow path of the cooling air system.

The hydrogen-based hydrogen discharge flow path may further include a merging portion that can merge with the reaction air discharge flow path of the reaction air system.

Has an independent blowing device in the reaction air system and the cooling air system, and, by the hydrogen discharge flow path merges with the cooling air discharge flow path, when the system is stopped, the fuel cell system stops the reaction air blowing device, and by driving the cooling air blowing device, the exhaust hydrogen can be diluted with cooling air and discharged to the outside of the fuel cell system.

The reaction air blowing device and the cooling air blowing device may be an air compressor, an air pump, an air blower, an air fan, and the like, respectively.

The reaction air system may have a reaction air inlet for taking the reaction air from the outside of the fuel cell system, and the reaction air inlet may be provided with a pressure loss body such as an air filter.

The cooling air system may have a cooling air inlet for taking cooling air from the outside of the fuel cell system, and a pressure loss body such as an air filter may be provided in the cooling air inlet.

The fuel cell system stops the supply of the reaction air to the fuel cell while continuing the supply of the hydrogen to the fuel cell and the supply of the cooling air to the fuel cell when the system is stopped, and closes the inlet-side sealing valve of the reaction air and the outlet-side sealing valve of the reaction air to seal the cathode of the fuel cell, and then stops the supply of the hydrogen to the fuel cell while continuing the supply of the cooling air to the fuel cell intermittently or continuously. After that, it may be after a predetermined period of time has elapsed, or after the voltage of the fuel cell has decreased to a predetermined voltage or less.

Then, the fuel cell system may shut off the cathode and the anode of the fuel cell from the outside of the fuel cell system when the system is stopped.

By stopping the fuel cell system according to the following stopping sequence, deterioration of the fuel cell can be prevented.

### (1) Stop Sequence 1

Purging and draining of the fuel-cell is performed as needed, and the air blower is turned OFF, and the inlet-side sealing valve and the outlet-side sealing valve of the reaction air system are closed to seal the reaction air system.

### (2) Stop Sequence 2

Then, the hydrogen-based purging water is discharged. The hydrogen purge valve may be opened and closed. At this time, the cooling-fan may be intermittently or continuously turned ON to dilute and evacuate the hydrogen.

After the voltage of the fuel cell drops to a predetermined value, the hydrogen purge valve and the hydrogen inlet valve are closed to seal the hydrogen system. After stopping the hydrogen purge valve, the hydrogen inlet valve may be closed after stopping the cooling fan. Closing the hydrogen purge valve stops the flow of hydrogen, so there is no need to dilute the hydrogen, so stopping the cooling fan may be either before or after closing the hydrogen inlet valve.

At the end of the power generation operation of the fuel cell, the cathode is sealed first, and then the hydrogen system is purged with opening and closing of the hydrogen purge valve, and then the hydrogen system is sealed. As a result, the inside of the battery of the fuel cell can be sealed in a hydrogen-rich state, and deterioration due to an abnormal potential of the fuel cell during stopping can be prevented.

In a case where the anode is sealed first in a condition in which the cathode is not sealed, oxygen continues to flow into the cathode, so that the inside of the cell of the fuel cell becomes insufficient in hydrogen and an abnormal potential state may occur.

In order to seal the cathode with a small volume, a flow path structure independent of the reaction air and the cooling air is formed.

After the cathode sealing, each blowing device may be provided in the reaction air system and the cooling air system in order to have to dilute and exhaust the purged hydrogen.

When the oxygen concentration decreases after the cathode sealing, when the voltage of the fuel cell decreases, an equivalent amount of hydrogen equal to or higher than the residual oxygen amount can be secured, and the hydrogen supply can be stopped.

When the fuel cell is flooded with a large amount of liquid water at the end of power generation of the fuel cell, for example, the flow rate of the air blower or the hydrogen pump may be increased before the sealing of the reaction air system, and the purging and drainage treatment of the fuel cell may be performed.

The fuel cell system may comprise an electrical system.

The electrical system may comprise a diode on a power line with the fuel cell and may further comprise a relay for the fuel cell. By having the diode, generation of a reverse current from the power line side to the fuel cell can be avoided. A power consumption absorbing device such as a secondary battery or a capacitor is connected to the power line.

The fuel cell system may connect the fuel cell to a power line of the electrical system when the system is shut down. The high potential of the fuel cell can be avoided during purging, and the voltage of the fuel cell can be lowered in a short time.

The electric potential of the fuel cell can be maintained at a constant V2 or less by performing the stopping process while the fuel cell is connected to the power line via the diode. When the above process is performed with the open circuit in which the relays are turned OFF, the voltage of the fuel cell becomes a high potential (0.9V exceeding) of the open circuit voltage (OCV), and the deterioration of the fuel cell proceeds. V2 may be set by a power absorbing device such as a battery or a capacitor to be connected so that the power of the fuel-cell is less than 0.85V. In addition, since the power is absorbed by the power consumption absorbing device after the cathode is sealed, oxygen is rapidly consumed by the power generation, and thus the stop process can be completed in a short time.

The hydrogen system may have a hydrogen pump for circulation. By providing a hydrogen pump, purging and draining can be efficiently performed with a small amount of hydrogen. In addition, the hydrogen concentration in the fuel cell can be quickly equalized, and deterioration of the fuel cell due to local hydrogen deficiency can be prevented.

The hydrogen system circulation is carried out by the hydrogen pump in the stop sequence 2, and the wastewater purging can be performed while the hydrogen discharge is suppressed. In addition, local hydrogen deficiency (=abnormal potential) can be prevented in the stop sequences 1 to 2.

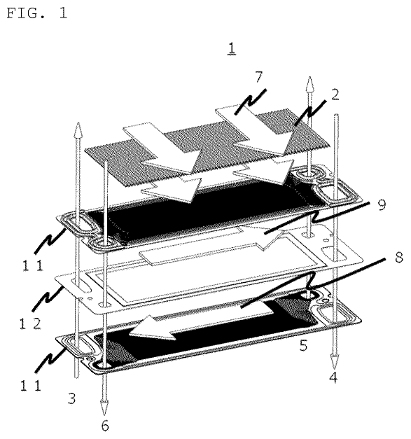

FIG. 1 is a schematic exploded perspective view showing an example of a unit cell of the fuel cell included in the fuel cell system of the present disclosure.

The unit cell 1 shown in FIG. 1 includes a cooling fin (cooling air flow path) 2 serving as a flow path for cooling air (cooling gas) 7, a reaction air inlet 3, a reaction air outlet 4, a hydrogen gas inlet 5, a hydrogen gas outlet 6, two separators 11, a MEA sandwiched between the two separators 11, and a resin frame 12. As shown in FIG. 1, the unit cell 1 of the fuel cell has a flow path structure in which the reaction air 9 and the cooling air 7 are independent from each other.

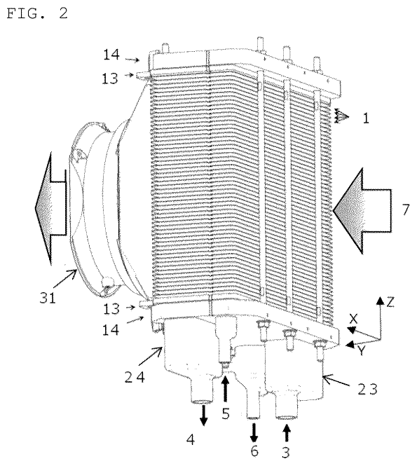

FIG. 2 is a schematic perspective view showing an example of a fuel cell stack included in the fuel cell system of the present disclosure.

The fuel cell stack shown in FIG. 2 is a stacked body in which a plurality of cells 1 are stacked, and includes a current collector plate 13 and a pressure plate 14 at both ends in the stacking direction.

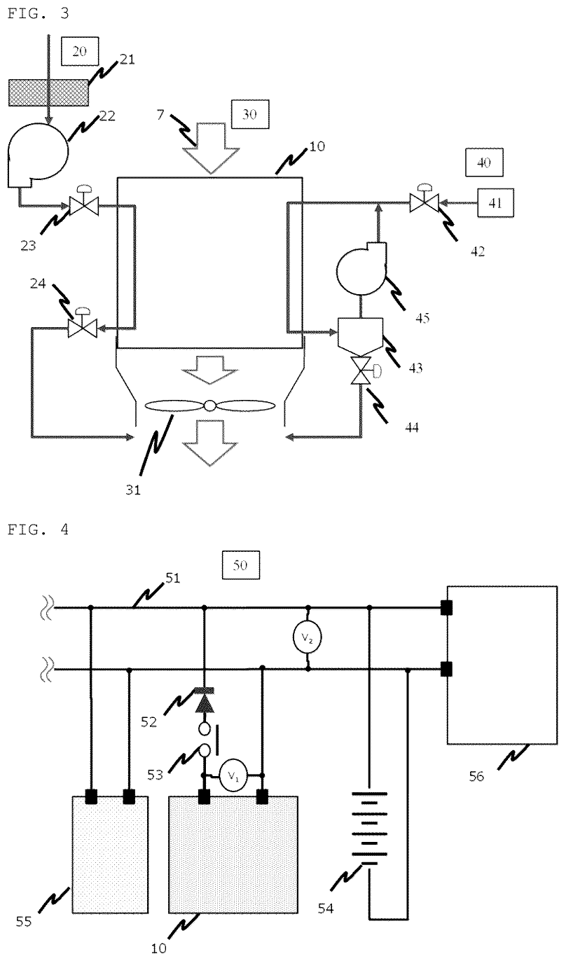

FIG. 3 is a system configuration diagram showing an example of the fuel cell system of the present disclosure.

The fuel cell system shown in FIG. 3 includes a fuel cell stack 10, a reaction air system 20, a cooling air system 30, and a hydrogen system 40. The reaction air system 20 includes a reaction air intake port 21, an air blower 22, an inlet-side sealing valve 23, and an outlet-side sealing valve 24. The cooling air system 30 includes a cooling fan 31. The hydrogen system 40 includes a hydrogen tank 41, a hydrogen inlet valve 42, a gas-liquid separator 43, a hydrogen purge valve 44, and a hydrogen pump 45. The fuel cell system shown in FIG. 3 includes sealing valves 23 and 24 at the entrance and exit of the reaction air system 20, and independent blowing device 22 and 31 for the reaction air system 20 and the cooling air system 30.

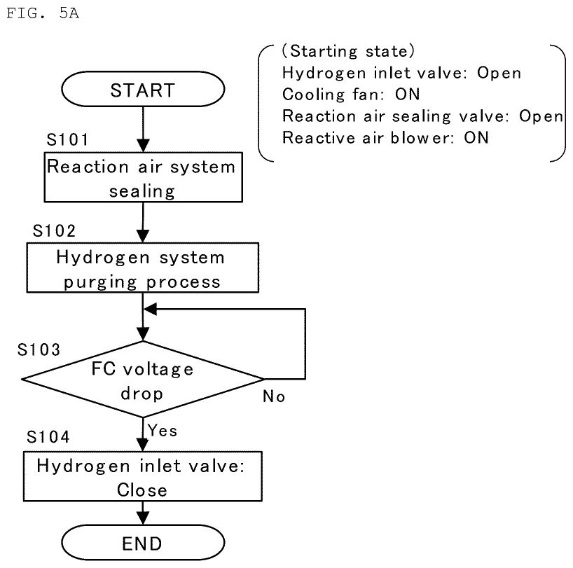

FIG. 4 is a circuit diagram showing an example of the electrical system included in the fuel cell system of the present disclosure.

The electrical system 50 shown in FIG. 4 includes a power line 51, a diode 52, a relay 53, power consumption absorbing device 54 such as a battery/capacitor, auxiliary equipment 55, and power consumption equipment 56.

By installing the diode 52 on the power line 51, the fuel cell stack 10 is connected to the power line 51 at the time of recovery control, so that it is possible to shorten the time of recovery control while avoiding the generation of a reverse current from the power line 51 side to the fuel cell stack 10.

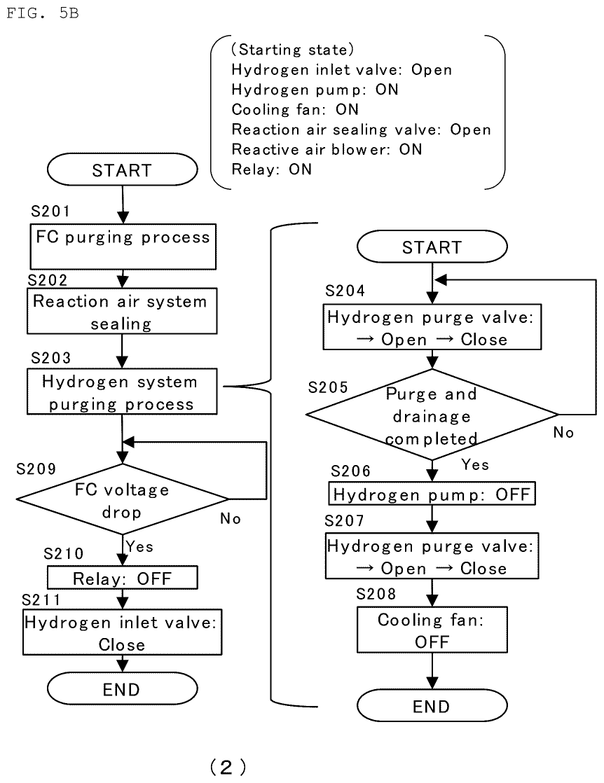

FIG. 5A and FIG. 5B are a flowchart illustrating an example of control of the fuel cell system of the present disclosure.

FIG. 5A shows a shutdown sequence of the fuel cell system.

At the beginning of the shutdown sequence, the following conditions are as follows: hydrogen inlet valve: open; cooling fan: ON; reaction air sealing valve (inlet side sealing valve and outlet side sealing valve): open; reaction air blower: ON.

The reaction air seal valve is closed to seal the reaction air system (S101).

The hydrogen purge valve is opened intermittently to start the hydrogen purging process (S102).

When the voltage of the fuel cell drops to a predetermined value (S103), the hydrogen inlet valve and the hydrogen purge valve are closed, the cooling fan is stopped (S104), and the control is ended.

FIG. 5B shows a shutdown sequence in a fuel cell system configuration including a hydrogen pump, a relay and a diode.

At the beginning of the shutdown sequence, the following conditions occur: hydrogen inlet valve: open, hydrogen pump: ON, cooling fan: ON, reaction air sealing valve (inlet side sealing valve and outlet side sealing valve): open, reaction air blower: ON, relay: ON.

Purging of the fuel cell is performed (S201). The purging process may be performed at a high flow rate of the reaction air (a stoichiometric ratio of 3 or more in the case of generating electricity, and a flow rate at which droplets in the flow path can move in the case of not generating electricity) for 5 seconds.

The reaction air sealing valve is then closed to seal the reaction air system (S202).

Thereafter, the hydrogen-based purging treatment is started (S203). The hydrogen-based purging may circulate the hydrogen pump at a high flow rate for a period of time while intermittently opening the hydrogen purge valve (S204).

A data group indicating the pressure fluctuation when the hydrogen purge valve is opened or the relationship between the cell temperature and the purging time may be prepared in advance, and it may be determined that the purging is completed with the passage of the purging time.

Turn OFF the hydrogen-pump (S206) after determining that purging is complete (S205). After the hydrogen pump is turned OFF, the hydrogen system is finally purged in order to discharge the liquid and the like accumulated in the gas-liquid separator. The final purge of the hydrogen system may open the hydrogen purge valve intermittently with the hydrogen pump turned OFF (S207).

After the final purge of the hydrogen system is completed, the exhaust hydrogen is diluted and exhausted to the outside of the fuel cell system by the cooling air, and then the hydrogen purge valve is closed to turn OFF the cooling fan (S208).

The fuel-cell voltage may be monitored and relayed OFF (S210) after the cell mean voltage falls below 0.4V (S209). After the relay is turned OFF, the hydrogen inlet valve is closed to seal the hydrogen system (S211), and the control is terminated.

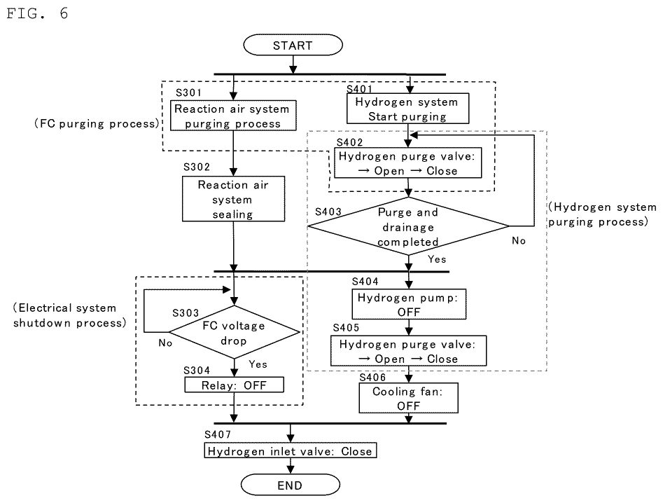

FIG. 6 is a flowchart showing another example of the control of the fuel cell system of the present disclosure.

As shown in FIG. 6, from the viewpoint of shortening the time of the stopping treatment, the purging process of the hydrogen system (S401) to (S407) may be performed in parallel with the purging process of the fuel cell (S301) to (S302) and the stopping process of the electric system (S303) to (S304).

After the sealing of the reaction air system, the generation of an abnormal potential of the fuel cell can be prevented by stopping the electric system and performing the final purge of the hydrogen system (diluting and discharging using cooling air) and the sealing of the hydrogen system.

### REFERENCE SIGNS LIST

1. Unit cell
2. Cooling fins (cooling air flow path)
3. Reaction air inlet
4. Reaction air outlet
5. Hydrogen gas inlet
6. Hydrogen gas outlet
7. Cooling air (cooling gas)
8. Hydrogen gas
9. Reaction air
10. Fuel cell stack
11. Separator
12. MEA, resin frame
13. Current collector
14. Pressure plate
20. Reactive air system
21. Reaction air inlet
22. Air blower
23. Inlet side sealing valve
24. Outlet side sealing valve
30. Cooling air system
31. Cooling fan
40. Hydrogen system
41. Hydrogen tank
42. Hydrogen inlet valve
43. Gas separator
44. Hydrogen purge valve
45. Hydrogen pump
50. Electric system
51. Power line
52. Diode
53. Relay
54. Power consumption absorbing device
55. Auxiliaries
56. Power consuming equipment

1. An air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent;
wherein the reaction air system comprises an inlet-side sealing valve at an inlet for the reaction air of the fuel cell and an outlet-side sealing valve at an outlet for the reaction air of the fuel cell; and
wherein, when the fuel cell system is shut down, the fuel cell system is configured to stop the supply of the reaction air to the fuel cell, while continuing the supply of the hydrogen to the fuel cell and the supply of the cooling air to the fuel cell; the fuel cell system is configured to close the inlet side sealing valve and the outlet side sealing valve to seal the cathode of the fuel cell; and then, the fuel cell system is configured to stop the supply of the hydrogen to the fuel cell, while continuing the supply of the cooling air to the fuel cell intermittently or continuously.

2. The fuel cell system according to claim 1,
wherein the reaction air system comprises a reaction air blowing device;
wherein the cooling air system comprises a cooling air blowing device; and
wherein a hydrogen discharge flow path of the hydrogen system merges with a cooling air discharge flow path of the cooling air system.

3. The fuel cell system according to claim 1,
wherein the fuel cell system comprises an electrical system, and
wherein the fuel cell system is configured to connect the fuel cell to a power line of the electrical system when the fuel cell system is shut down.

4. The fuel cell system according to claim 1, wherein the hydrogen system comprises a hydrogen pump.

5. The fuel cell system according to claim 1,
wherein the fuel cell comprises at least one of unit cell,
wherein the unit cell comprises an anode separator, a power generation unit, and a cathode separator, in this order,
wherein the cathode separator comprises the reaction air flow path on the side of the power generation unit, and comprises the cooling air flow path on the side opposite to the power generation unit.

6. The fuel cell system according to claim 5,
wherein the unit cell comprises a corrugated cooling fin as the cooling air flow path.

7. The fuel cell system according to claim 1,
wherein when a predetermined period of time has elapsed, or when the voltage of the fuel cell has decreased to a predetermined voltage or less, the fuel cell system is configured to stop the supply of the hydrogen to the fuel cell, while continuing the supply of the cooling air to the fuel cell intermittently or continuously.
